(19) United States
(12) Patent Application Publication
(10) Pub. No.: US 2011/0138409 A1
(43) Pub. Date: Jun. 9, 2011

(54) METHOD OF MANAGING RESTRICTED MEDIA CONTENT IN A TV SYSTEM

(75) Inventors: Magnus Svensson, Stockholm (SE); Mathias Bogebrant, Huddinge (SE)

(73) Assignee: TELEFONAKTIEBOLAGET L M ERICSSON (PUBL), Stockholm (SE)

(21) Appl. No.: 13/055,367

(22) PCT Filed: Jul. 15, 2009
(86) PCT No.: PCT/SE2009/050903

§ 371 Date: Jan. 21, 2011

Related U.S. Application Data
(60) Provisional application No. 61/089,103, filed on Aug. 15, 2008.

(51) Int. Cl. H04N 7/16

(52) U.S. Cl. 725/25

(57) ABSTRACT

A method in a communication network and an IPTV Control Server (140) for managing of restricted media content. The media content may be restricted in different ways. For instance the media content may be restricted for users below a certain age or the content has to be payed for and the user account is empty. According to the invention a Guardian, who is remote, receives a message to a mobile terminal with an authorization request. The guardian can accept or reject the authorization request. The guardian terminal does not need to have an application for remote authorization running on the terminal.

### TECHNICAL FIELD

The invention generally relates to delivery of media content in a communication system and more particularly to remote authorization of restricted content in a TV system.

### BACKGROUND

As television (TV) moves from one-way distribution toward two-way interactive communication networks and from being watched in one location towards being watched anywhere on all types and sizes of screens, we will witness the birth of an entirely new mass market for TV program advertising, interactive games and other services. Interactivity through wireline and wireless two-way networks will make it possible for viewers to participate in many ways, for example, to vote in TV shows, to buy products by interacting with advertisements, and to send personal messages to TV shows. The viewer will have new possibilities when it comes to personalization, for example, what ads to receive in targeted advertising, how TV programs are listed in an electronic program guide (EPG), which program content to consume and when, etc.

Internet Protocol Television (IPTV) offers new revenue opportunities for telecom service providers when it comes to attracting new customers to their networks in order to offset declining voice traffic revenues. It may be that wireline telecom service providers will move into IPTV to a great extent. With IPTV, telecom service providers can start to compete with TV offerings from cable operators, satellite-TV operators, and other terrestrial service providers. IPTV also helps providers retain existing customers and prevent churn by introducing a bundled offering of Internet, voice, and IPTV services (so-called “triple play”).

IPTV uses web-browser technology to enable IPTV Service Providers to provide media services deployed in communication networks, such as wired and wireless telephone networks. Common web browser applications enable users to view specific Internet pages and other file locations accessible by the browser. Each page is typically identified by a Uniform Resource Identifier (URI) or similar page address.

In an IPTV system multimedia streams are encoded as series of IP data packets. Work on IPTV is underway in several contexts, including for example the Open IPTV Forum, which is specifying an end-to-end platform for supplying multimedia and IPTV services to user equipments (UEs) over the Internet and managed networks having controlled quality-of-service (QoS) performance. A version 1.1 specification of a functional IPTV architecture is available at www.openiptvforum.org, and the architecture uses the IP Multimedia Subsystem (IMS) that is specified by the Third Generation Partnership Project (3GPP). A UE can access services offered through an IMS in many ways, both wired (e.g., Ethernet, cable modem, digital subscriber line, etc.) and wireless (e.g., 3GPP-specified cellular radio, IEEE 802.11, IEEE 802.16, etc.).

The IMS is specified in 3GPP Technical Specification (TS) 23.228 V8.4.0, IP Multimedia Subsystem (IMS) Stage 2 (Release 8), March 2008, and previous versions of TS 23.228. IMS for IPTV is described in, for example, article “Network Infrastructure for IPTV”, Ericsson Review No. 3, pp. 79-83 (2007). Approaches to IMS-based IPTV are described in M. Cedervall et al., “Open IPTV Forum—Toward an Open IPTV Standard”, Ericsson Review No. 3, pp. 74-78 (2007), and T. Cagenius et al., “Evolving the TV experience: Anytime, Anywhere, Any Device”, Ericsson Review No. 3, pp. 107-111 (2006).

The IMS in 3GPP networks uses the Session Initiation Protocol (SIP) and the Session Description Protocol (SDP) as its basic signaling mechanisms. SIP is a mechanism defined in Request for Comment (RFC) 3261 by the Internet Engineering Task Force (IETF) for finding endpoints and routing control signals between them and is a set of simple operations, including REGISTER, INVITE, ACK, and BYE. SDP is a protocol for declaring media. In IMS networks, media transport is based on the real-time transport protocol (RTP), among others. 3GPP TS 24.229 V7.11.0, IP Multimedia Call Control Protocol Based on Session Initiation Protocol (SIP) and Session Description Protocol (SDP), Stage 3, Release 7 (March 2008) specifies an IP Multimedia Call Control Protocol based on SIP and SDP. Section 5 of TS 24.229 specifies SIP usage at a UE, and Section 6 of TS 24.229 specifies SDP usage.

For a UE, which for IPTV can be a set-top box (STB) or a TV having integrated STB capabilities, to access an IMS and IPTV services, the UE registers in a serving call session control function (S-CSCF), which is an IMS core node and is in essence a SIP server. The IMS also includes a number of access nodes, including a proxy CSCF (P-CSCF), a media gateway control function (MGCF), and one or more border gateways (BGs), that mediate UE access to the core nodes and through them to media content residing on media servers. The UE may include an IP multimedia subscriber identity module (ISIM), which is an application, or computer program, residing on a universal integrated circuit card (UICC) that enables the UE to register and access the IMS. The ISIM is typically preconfigured with parameters necessary to initiate the UE's registration to the IMS, including a private user identity, one or more public user identities, and a home network domain name.

Thus, in an IMS IPTV system, user login is a way to keep information on who is watching TV. It is also possible to deny access to certain TV programs for certain users. This is managed by use of a user profile in the IPTV system. For instance a user may be denied access to a certain movie.

In a EU project named Amigo it is described a way for a father or mother to allow a child to watch a movie. This is described in chapter 3.8 Parental Control, see below

http://www:hitech-projectss.com/euprojects/amigo/deliverables/amigo_d6.4_final.pdf and http://www:hitech-projectss.com/euprojects/amigo/index.htm):

The solution in the Amigo project is dependent on that a parental control application is installed on a PC or on a telephone terminal. The Amigo solution is therefore one way of implementing a solution for parental control and parental authorization.

In the current TV system and in current parental control systems there is no interactive way to monitor and control the TV system unless there is an application running on the terminal that is used to do the accept or reject. With the increasing amount of content distributed to the TV system at home one might want to be able to manage the media content also without such an application running on a terminal used for parental control.

### SUMMARY

With the increasing amount of content distributed to the TV system at home you might want to be able to manage the media content also from a remote location, by use of any terminal, if you are a parent.

By using the feature of the invention a remote user can accept or reject to temporary override a parental control protection of a specific content. A user restricted by parental control could ask the user of a subscription listed as guardian for permission to view the content. According to the invention any user terminal can be used for allowing or rejecting restricted content.

The invention relates to a method of managing restricted media content distributed in a TV System, the TV system including a Set Top Box with a user being logged into the TV system and the user being denied access to a media content. According to the invention the user initiates or sets a request for a remote authorization. This is done by generating in the STB a first request authorization message which includes at least an identifier of the user and an identifier of the content that the user wants to be able to view. The generated first request authorization message is then sent to a Control Server in the TV system. The Control Server processes the information in the first request and generates a second request authorization message which includes the identifier of the user, information about the media content that the user wants access to and a Guardian Terminal Identifier. The generated second request message is being sent to the Guardian Terminal.

The method further relates to the possibility for the user of the Guardian Terminal to make a response to the second request. The method then further includes the steps of responding from the Guardian Terminal to the second authorization request message and this response message, Yes or No, is forwarded by the Control Server to the STB.

For the purpose of generating the second request authorization message the method also includes the steps of fetching from a User Profile Server information about the Guardian Terminal and collecting Meta Data for the media content, which Meta Data can be presented on the Guardian Terminal when the Guardian Terminal gets the second authorization request.

If the Guardian Terminal send away a Yes response which is an accept message then the access rights are being updated in the User Profile Server and a link to the media content is included in the response message to the STB.

The Guardian terminal may be for example an IMS terminal and then the second authorization request message is a SIP message. The Guardian may for example be a regular terminal for SMS and then the second authorization message may be sent as an SMS message instead.

Further, the invention relates to a method in a Control Server. The method relates to remote authorization of restricted media content distributed in a TV System, the TV system including a Set Top Box with a user being logged into the TV system and the user being denied access to a media content. The Control Server is receiving a first request authorization message from the STB, the message including at least an identifier of the user and an identifier of the media content. Then it is generated in the Control Server a second request authorization message which includes the identifier of the user who is making the request together with information on the content for which the request is made. The request is then sent to the Guardian Terminal.

The invention further includes the method steps that the Control Server is receiving an accept or reject answer from the Guardian Terminal and then the Control Server is in a method step forwarding the accept/reject message to the STB.

The Control Server further includes a step to generate the second request authorization message. The step is to fetch information on a Guardian Terminal and Guardian Terminal Type in order to determine how and where to deliver the second request.

The Control Server further includes a link to the media content into the authorization message if it is an accept message.

The Control Server further includes the feature to send a reject message to the STB if there is no answer from the Guardian Terminal within a predefined time limit.

The invention further relates to a Control Server for managing restricted media content in a TV system, the TV system including a Set Top Box with a user being logged into the TV system and the user being denied access to a media content. The STB may be any kind of TV set. The Control Server comprising a Receiver to receive a first request authorization message from the SIB and an Interface configured for exchanging electronic signals with a Guardian Terminal. The Control Server also comprises a Remote Authorization Application Memory where the Remote Authorization Application is stored and further the Control Server contains a Processor configured to generate a Response to the received request by use of the Remote Authorization Application and the electronic signals from the Guardian Terminal. The Control Server contains a Transmitter for transmitting the generated response message back to the STB.

The Control Server may in one embodiment be an IPTV Control Server.

### SHORT DESCRIPTION OF THE DRAWINGS

The invention may more readily be understood by making reference to the following description taken together with the accompanying drawings, in which:

FIG. 1 is a simplified schematic overview of a communication system, to which the teachings of the invention can be applied.

FIG. 2 is a sequence diagram illustrating signals in the communications system according to an IMS embodiment of the invention.

FIG. 3 is a sequence diagram illustrating signals in the communications system according to an SMS embodiment of the invention.

FIG. 4 depicts a Media Content Database in an IPTV Control Server or connected to an IPTV Control Server.

FIG. 5 shows a block diagram of the IPTV Control Server and

FIG. 6 shows a User Profile Server in the communication system.

### DETAILED DESCRIPTION

Throughout the drawings, the same reference characters will be used for corresponding or similar elements.

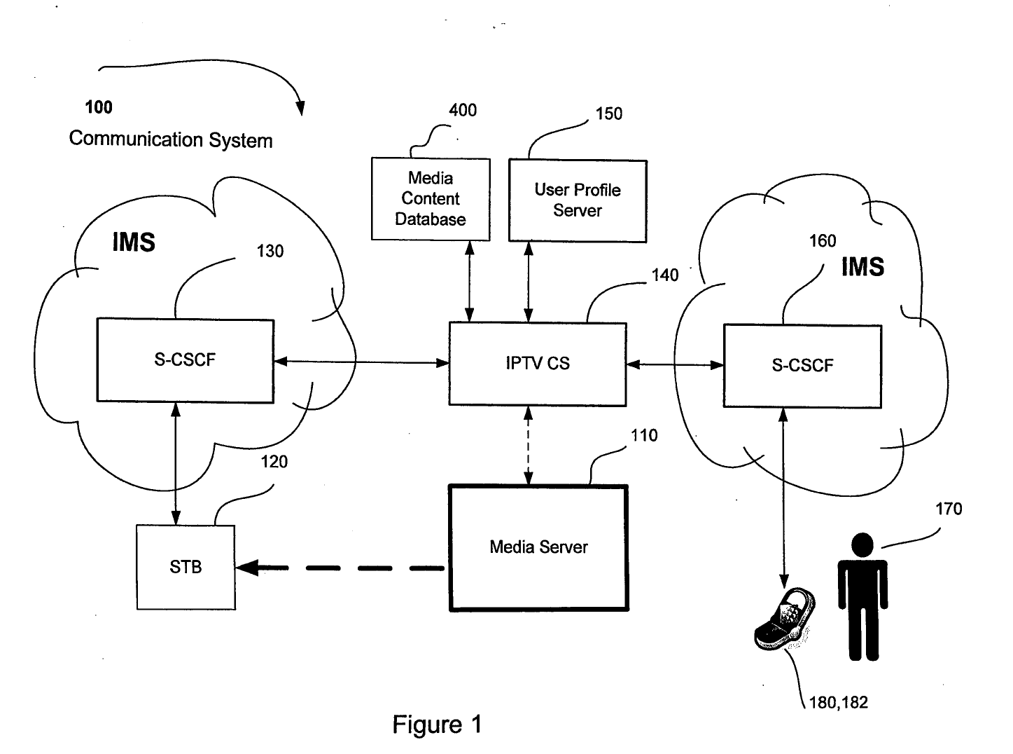

FIG. 1 relates to a communication system 100 including a Media Server 110 for delivering of media content to clients which in this description are represented by a Set Top Box STB 120. Throughout the description the term Set Top Box is used but it may be interpreted as any TV set having the same functionality. The Communication System 100 may be named as just TV system which is implemented as an IPTV System. In a TV System it is possible that media content is restricted for a user for specific reasons. A reason may be that a child is not allowed to watch movies rated not to be appropriate for watchers below 15 years. Another reason for restriction may be that a users account is empty, indicating that the user can not pay the price for the movie. The inventors have recognized that media content may be OK anyway if a guardian temporarily allow a user to watch restricted content. The inventors have also recognized that such restricted content can be authorized by a guardian remotely which has the advantage that a guardian, for instance a parent, does not need to be at home when allowing a child to watch the restricted content.

In this invention a guardian is having a terminal with authorization rights user so that the Guardian Terminal/Client 180, 182 can give permissions to users for example to watch restricted content. The Guardian Terminal is having a Guardian Terminal ID.

The Communication System 100 in FIG. 1 utilizes the advantage of an IMS system and includes a first IMS core node, a S-CSCF 130 for the log in procedure which is not further described since it is prior art knowledge. The Communication System 100 is a simplified figure of the system. For instance there are more IMS nodes than described involved in the login procedure and the S-CSCF 130 is a representation of the IMS system for login, which is indicated in the figure by an IMS cloud.

However, it is a prerequisite for the invention that the user is logged into the TV system and in this example the TV system is an IMS system which is aware of who is watching TV. The S-CSCF 130 is connected with an IPTV Control Server 140 (which can also be named IPTV Application Server IPTV AS or IPTV Application Platform IPTV AP) running a Remote Authorization RA application. The IPTV CS 140 is connected with an IPTV User Profile Server 150 storing user profiles about access rights among other things. The IPTV CS 140 is connected with a S-CSCF 160 (which may be the same node as S-CSCF 130) used for contacting a Guardian 170 who can allow access to restricted content in accordance with the invention. The Guardian 170 may according to the invention receive an Authorization Request message on a device 180, 182. The device may be a mobile phone or an IMS terminal. The Guardian has the possibility to allow or reject the request by sending a response from the Guardian Terminal 180, 182 to the IPTV CS 140. If the request is accepted the Media Server 110 will be able to deliver the media. In order to manage the delivery of media the system 100 includes a Media Content Database 400 and a User Profile Server 150, both connected to the IPTV CS 140.

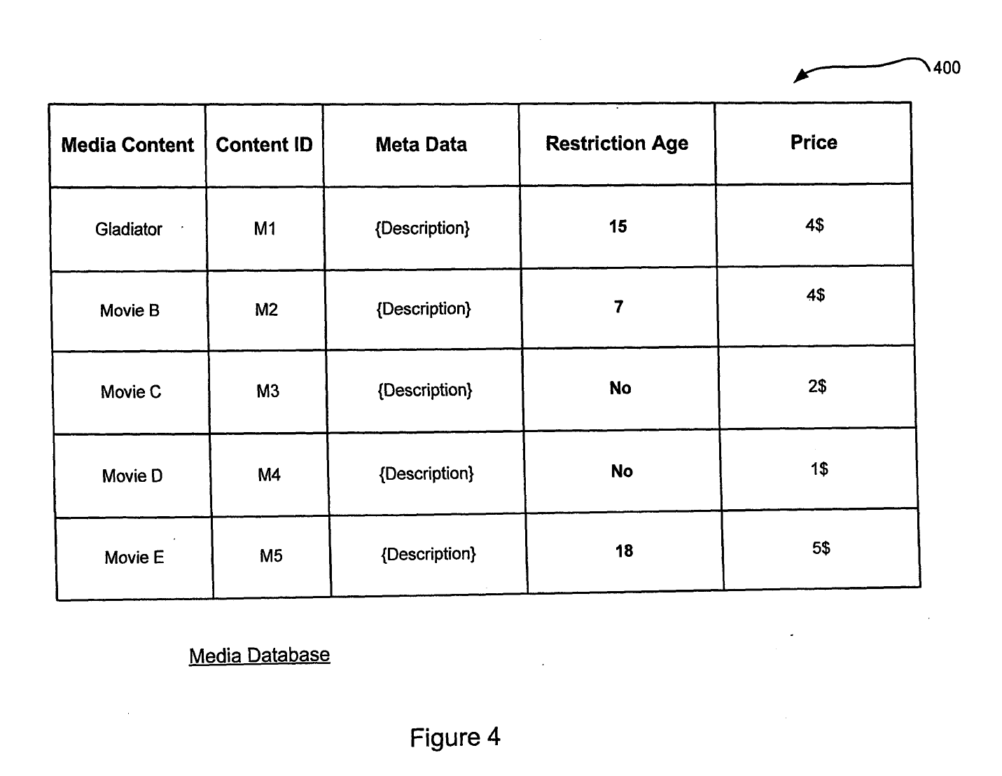

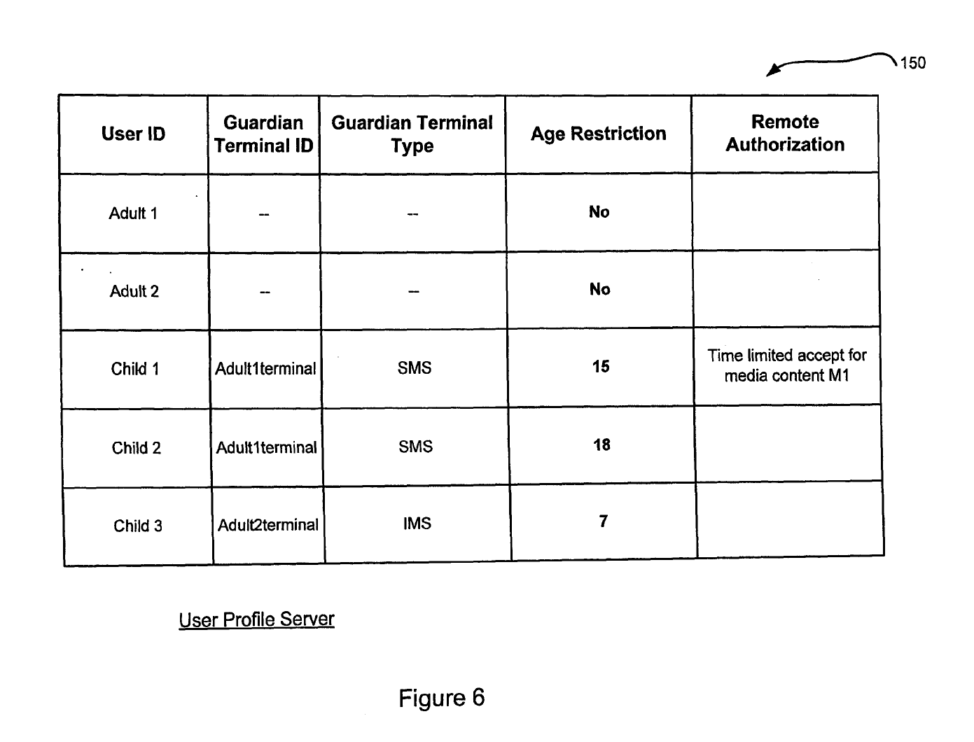

The scenario for this invention is that a user is logged into the IPTV system 100 which for example is done in accordance with prior art technology. The user wants to watch a media content which for instance is a Movie A restricted for people under 15 years, see FIG. 4 first row. The FIG. 4 shows in more details the Media Database 400 containing information about the media or different movies. The IPTV CS 140 manages all required checks before the media stream can be delivered to the user. In this case the IPTV CS 140 compares information in the Media Content Database 400 with information in the IPTV User Profile Server 150. The logged in user is 14 years old according to information in a user profile of the IPTV User Profile Server 150 and the system will deny access to the media content Movie named “Gladiator”. In the User Profile this is indicated as the user has an Age Restriction 15 years (See FIG. 6) The System will deny access because the user profile is not compatible with the age restriction in the Media Content Database 400. According to the invention the user then has the possibility to Request Authorization from a Guardian, which often is a parent, who can permit access to the “Gladiator” movie for the 14 years old user. This Age Restriction is just an example. In practice there is a rating system which categorizes films with regard to different issues such as sex, violence etc. Thus in theory the rating could be based on pure age but in practice the rating will be done by a more diversified rating system.

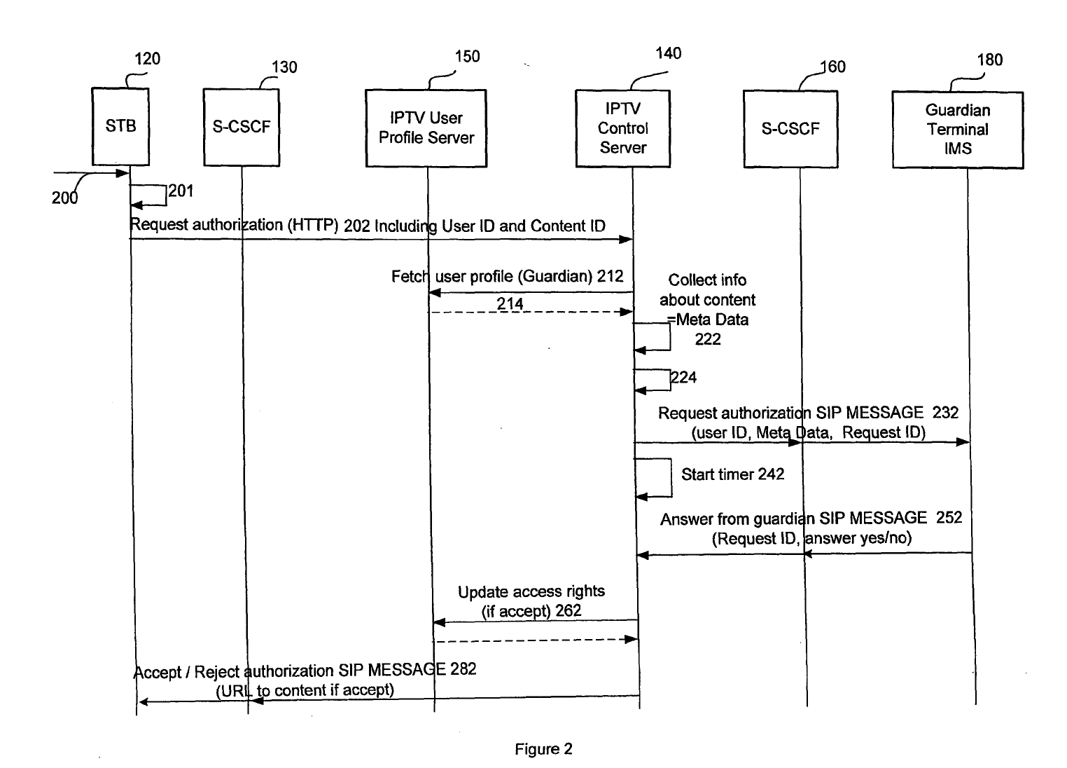

FIG. 2 depicts a typical signal flow among entities in a communication System 100 in methods of remote authorization of restricted media content in accordance with the invention. It will be understood that the methods depicted are in a context of IMS, employing messages appropriate for IMS, but in general other contexts and other types of messages can be used.

In step 200, a user sets a request for a Remote Authorization, for example by accessing a suitable webpage for Remote Authorization in an IPTV Portal through an IPTV terminal function ITF in the STB 120. The user indicates to the ITF a request for a Remote Authorization for the mentioned movie which the user previously has been denied access to. This is done by clicking on the User Equipment display of a particular button or other control device associated with Remote Authorization request.

In step 201, the user's ITF IPTV Terminal Function of the STB 120 (which is conventionally logged in to the IMS system via the S-CSCF 130) generates a first request authorization message. The message includes the identifier of the user/requestor User ID and an identifier of the media content Content ID that access was denied for. In step 202 the ITF/STB 120 is sending the generated first request authorization message to the IPTV Control Server CS 140 in an HTTP message. The artisan will understand that HTTP request messages are just examples of request messages and that other kinds of messages, such as SIP and other protocols can be used.

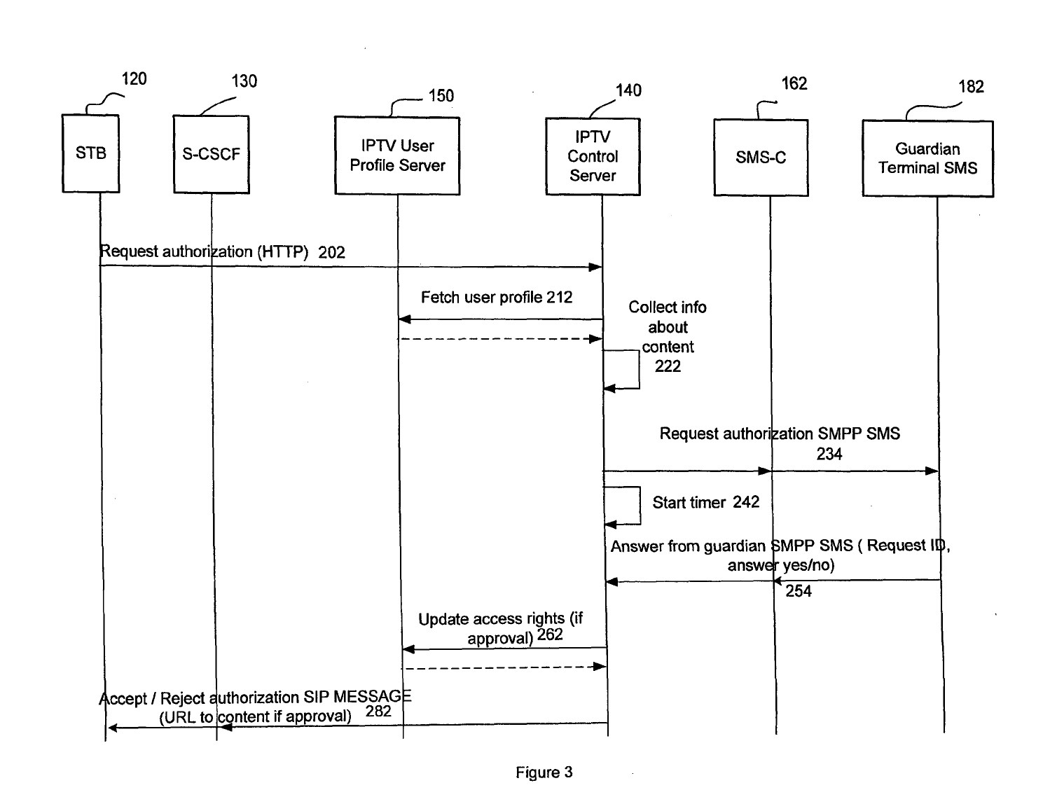

Upon reception of the request authorization message the IPTV CS 140 fetches 212 the user profile of the requesting user from the IPTV User Profile Server 150. In the user profile there is information on who is a Guardian who can authorize access to denied content. The Guardian is represented by a Guardian Terminal ID in the User Profile Server. In step 214 the profile is returned to the IPTV CS 140. This information could also be stored locally in the IPTV CS 140. The IPTV Control Server now has information on the Guardian Terminal ID together with info illation on how to send a request to the Guardian. This information is retrieved from the information “Guardian Terminal Type” in the User Profile Server. Depending on the type of terminal the request can be sent as a SIP message to a SIP/IMS terminal as described in connection with FIG. 2 or as an SMS message as described in connection with FIG. 3.

The IPTV User Profile Server 150, shown in FIG. 6, is also used for storing information about an account for the user. Each media content has a price connected to it and the price is what is needed to pay for the movie. If the user is out of money on the account and wants to watch a movie, the system will deny the user from watching the movie. In such a case remote authorization can also be used.

FIG. 6 shows a simplified example of the User Profile Server 150. In the figure there is a column for User ID where the data for the logged in user is stored. The next column refers to a Guardian Terminal ID which is the information on which Guardian Terminal to turn to in case of an authorization request. For instance if an authorization request is sent from Child 1 then the Guardian Terminal ID is identified to “Adult1terminal”. Also the User Profile Server contains information on the Guardian Terminal Type. There is an Age Restriction column where the system can find the information that Child 1 cannot see movies having an age restriction 15. Child 1 will be denied delivery of movies with age restriction 15. The last column “Remote Authorization” has information about actual remote authorizations done for the user. For instance if there is a remote authorization done information is entered into this column. This is done to temporarily update access rights in the User Profile Server. The User Profile Server may also contain account information on money possible to use for movie. However, this information is not shown in the figure.

Upon request for media content from a user the IPTV CS 140 compares information in the User Profile Server 150 with information in the Media Content Database 400. For example, when Child 1 makes a request for the movie Gladiator then the IPTV CS 140 will fetch “Restriction Age” data from the Media Database and compare with “Age Restriction” data in the User Profile server. Child 1 will be denied access to the movie since it has an age restriction 15 and in the profile there is an indication for restrictions for that that type of movies. The Child 1 will be denied access but can instead according to the invention make a request for remote authorization.

In the IPTV Control Server 140 there is also a Media Database with information about content or the IPTV Control Server has access to such an external database. The database 400 is shown in FIG. 4. The database contains information about the media. The Media Content column contains name of the movie, such as “Gladiator” having Content ID “M1”. The database also includes a summary of the movie under column “Movie Summary” or “Meta Data” containing different kind of information about the movie such as actors, play time, year of production, producer, movie summary etc. There is information on Restriction (Age) in a further column and price in the last column.

In step 222 the IPTV CS 140 is collecting information (Meta Data) about the content media for which access is requested. In step 224 the IPTV CS 140 is generating a second request authorization message which at least includes the identifier of the requestor/user (User ID), data about the content (Meta Data) and the Guardian Terminal ID so that the second request message can be sent to the Guardian Terminal appointed for this user. Thus, the second request authorization message is based on information in the first request authorization message. The message also includes a Request Identifier (Request ID) for the CS to keep track of the request and a later response.

In step 232 the IPTV CS 140 is sending the second request authorization message to the IMS client 180 of the Guardian Terminal, via the IMS node S-CSCF 160.

The Guardian Terminal 180 of the Guardian 170, which usually is a parent, receives (step 232) the second request authorization message and make a decision on accepting the request or making a rejection of the request. The Guardian just enters a Yes if the request is accepted or a No if the request is not accepted. There is no need for the Guardian to have a special Remote Authorization application running on the terminal.

There is a validity time of the request. In step 242 a timer is started, the timer having a predefined time limit. The purpose of the timer is to be able to respond back to the STB even if the guardian doesn't reply. In that case it will be a negative (Rejection) response back. If there is no response received in the IPTV CS140 within the time limit then a rejection message is being sent to the STB from the IPTV CS.

In step 252 the Guardian User 170 is accepting or rejecting the authorization request in an answer being sent as a SIP message from the Guardian Terminal 180 to the IPTV Control Server 140. The SIP MESSAGE contains at least the request identifier, Request ID and the answer yes/no. Optionally also the Guardian ID is in the SIP MESSAGE. The request ID is an identifier that is used by the IPTV CS to keep track of the request and when it is responded to.

In step 262 the IPTV Control Server 140 updates the access rights of the user in the IPTV User Profile Server 150. According to the FIG. 6 the User Profile Server has a “Remote Authorization” column for storing information about remote authorizations made for temporary permissions for a child to see a movie. This update results in that the user who is requesting temporary access to the content is allowed to watch the content for a limited time. Thus according to access rights in the user profile the user now is able to receive the media content which normally is restricted to the user. The access is limited to a specific time.

In step 282 the IPTV Control Server 140 is sending an Accept or Reject authorization SIP MESSAGE to the ITF client of the STB 120. If the message is an accept message also the link which may be an URL to the media content is included in the message.

In step 242 a timer started. If there is no answer (SIP MESSAGE 252) from the guardian within a specified time, for instance 30 minutes, the IPTV Control Server 140 sends a Reject authorization SIP MESSAGE 282 to the STB 120.

Below is an example of an SIP MESSAGE in step 282 in the case of approval/accept or the request.

```
Message Header
  To: <sip:sara@ims.ericsson.com>
    SIP to address: sip:sara@ims.ericsson.com
  From: <sip:AuthorizationService@iptv.ericsson.com>;tag=f2adgz82-41
    SIP from address: sip:AuthorizationService@iptv.ericsson.com
    SIP tag: f2adgz82-41
  Call-ID: 10.2.6.123_35_616382494339554830
  CSeq: 1 MESSAGE
    Max-Forwards: 68
    Content-Length: 638
```

| | |
|---|---|
| Via: | SIP/2.0/UDP |

```
130.100.86.35:6050;branch=z9hG4bKb50dc2328a0d728de6822a987bd79eefdaaaaaaiaaaaaaszsz
0qa3Zqkv5buvt3ff32dhbhq
    Content-Type: text/html
    P-Called-Party-ID: <sip:sara@ims.ericsson.com>
  Message body
    Line-based text data: text/html
      <!DOCTYPE HTML PUBLIC “-//W3C//DTD HTML 4.01//EN”
“http://www.w3.org/TR/html4/strict.dtd”>
      <HTML>
      <HEAD><TITLE>
      Message from AuthorizationService
```

| | |
|---|---|
| </TITLE><link | rel=‘stylesheet’ |

```
href=‘../resources/themes/orangemetal_ntsc/css/overlay_html.css’ type=‘text/css’ media=‘screen’
charset=‘utf-8’></HEAD>
      <BODY style=‘background: transparent;’>
      <div id=‘overlay_html_content’ class=‘active’>Your Remote Authorization request for
“Gladiator” has been accepted, follow <A HREF=“http://10.2.6.123:8080/iap-stbportal-
war/portal/vodpresentation.html?vodbyid=es.vod.OFP18692” TARGET=“_paren
      </div></BODY>
      </HTML>
```

Below is an example of an SIP MESSAGE in step 282 in the case of a rejection of the request.

```
Message Header
  To: <sip:sara@ims.ericsson.com>
    SIP to address: sip:sara@ims.ericsson.com
  From: <sip:AuthorizationService@iptv.ericsson.com>;tag=f2adgjjd-4k
    SIP from address: sip:AuthorizationService@iptv.ericsson.com
    SIP tag: f2adgjjd-4k
    Call-ID: 10.2.6.123_34_903073236440343684
    CSeq: 1 MESSAGE
    Max-Forwards: 68
    Content-Length: 477
```

| | |
|---|---|
| Via: | SIP/2.0/UDP |

```
130.100.86.35:6050;branch=z9hG4bK46e368abe6468c6aadcb6fa352d03235daaaaaaiaaaaaapp
jzasq3Zqkv5buvt3fft3akaca
    Content-Type: text/html
    P-Called-Party-ID: <sip:sara@ims.ericsson.com>
  Message body
    Line-based text data: text/html
      <!DOCTYPE HTML PUBLIC “-//W3C//DTD HTML 4.01//EN”
“http://www.w3.org/TR/html4/strict.dtd”>
      <HTML>
      <HEAD><TITLE>
      Message from AuthorizationService
```

| | |
|---|---|
| </TITLE><link | rel=‘stylesheet’ |

| | |
|---|---|
| href=‘../resources/themes/orangemetal_ntsc/css/overlay_html.css’ | type=‘text/css’ |

```
media=‘screen’ charset=‘utf-8’></HEAD>
      <BODY style=‘background: transparent;’>
      <div id=‘overlay_html_content’ class=‘active’>Your Remote Authorization request for
“Gladiator” has been rejected.</P>
      </div></BODY>
      </HTML>
```

FIG. 3 is similar to FIG. 2 but is a second embodiment in which the authorization request is sent to the Guardian Terminal 182 via SMS. Thus the difference is that in step 234 the request authorization message is sent as an SMS message via an SMS-C and parlay X gateway node 162 to the Guardian user terminal 182 which is not an IMS terminal but a regular mobile phone or PC that can receive SMS messages. For sending of the SMS message 234, the IPTV Control Server 140 can communicate via IP messages with the Parlay X Gateway, which can translate a Web Services method call to one or more short message peer-to-peer protocol (SMPP) messages that the Parlay gateway communicates to the SMS-C. Parlay X is a standardized, open application programming interface (API) for current and next generation communication networks that enables creation of applications using telecom network capabilities, such as SMS and user interaction.

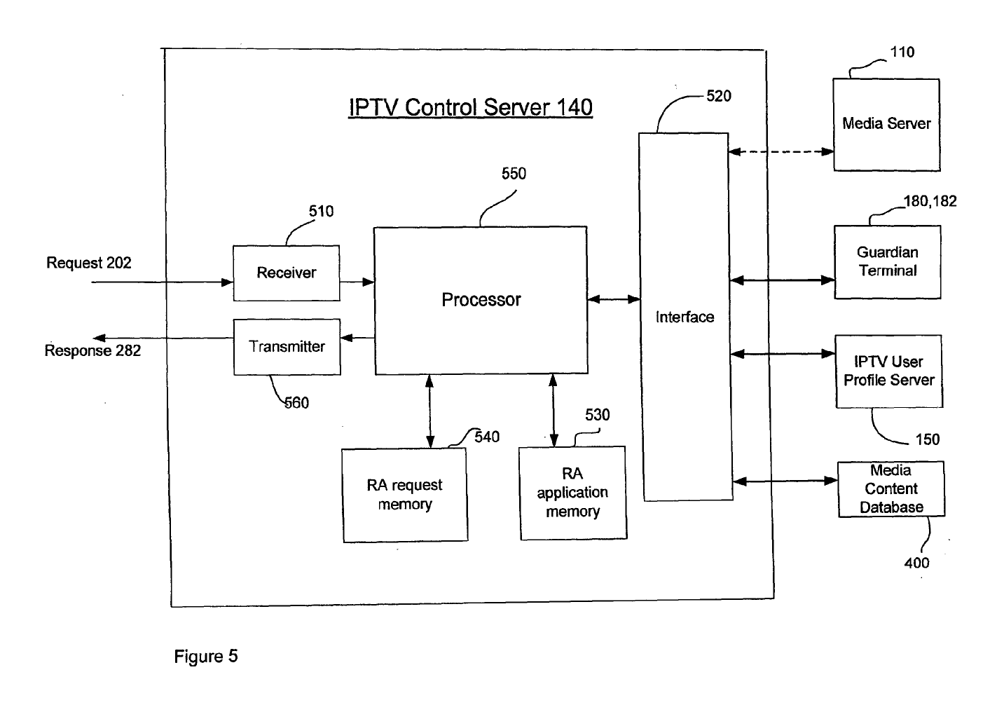

FIG. 5 describes the IPTV Control Server 140 which has the function of managing restricted media content in a Communication System which in this invention is exemplified by a IPTV system 100 (see FIG. 1). The IPTV Control Server 140 comprises a Receiver 510 configured for receiving the first request authorization message from a STB 120. The generation 201 and sending 202 of this message is described in connection with FIG. 2. The IPTV Control Server comprises an Interface 520 configured for exchanging electronic signals with a Guardian Terminal 180, 182. The Interface 520 is also connected with the IPTV User Profile Server 150 and with the Media Content Database 400 described in FIG. 4. Those signals 232, 252, 234, 254 are described in connection with FIGS. 2 and 3. A Processor 550 is connected with the Receiver 510 and the Interface 520 and with a Remote Authorization RA application memory 530 where a Remote Authorization Application is stored. The RA application controls all the events in the Processor 550 and thus controls the Processor in a way such that the Processor generates a response 282 to be sent to the STB. The response message 282 (Accept or Reject), which depends on the electronic signals from the Guardian Terminal 180, is described in connection with FIG. 2. Thus, the Response is generated by the Processor 550 by use of the Remote Authorization Application and the electronic signals from the Guardian Client 150. A Transmitter 560 is connected with the Processor 550 and configured for transmitting an Accept or a Reject message 282 which is sent back to the requesting party at the STB.

The IPTV Control Server 140 also comprises a Remote Application request memory 540 for correlating the response 282 with the first request authorization message 202. This means that the Processor adds the earlier mentioned Request Identifier ID to each incoming request message 202 and stores information from the message in the RA request memory 540. The response message from the Guardian also includes the request ID and when a response message 282 has been sent to the STB the request may be deleted from the memory 540.

The advantage of this invention is therefore that the parent or Guardian does not need to have a special application running on the Guardian Terminal. The Guardian can do a Remote Authorization only by responding Yes or No to an authorization request from a child via the Control Server and the Control Server sends a message to the Guardian including all necessary information to judge if the request shall be approved or rejected.

The invention may be embodied in many different for is, not all of which are described above, and all such forms are contemplated to be within the scope of the invention. For each of the various aspects of the invention, any such form may be referred to as “logic configured to” perform a described action, or alternatively as “logic that” performs a described action. It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

1. A method of managing restricted media content distributed in a TV System, the TV system including a Set Top Box (STB) with a user being logged into the TV system and the user being denied access to a media content, said method comprising the steps of:
generating in the STB a first request authorization message that includes at least an identifier of the user and an identifier of the media content;
sending the first request authorization message to a Control Server in the TV system;
the Control Server retrieving from a user profile of the user a Guardian Terminal Identifier representing a Guardian who can authorize access to denied content for that user;
generating in the Control Server a second request authorization message, including the identifier of the user, information about the media content and said Guardian Terminal Identifier;
sending the second request authorization message to the Guardian Terminal by use of the Guardian Terminal ID, wherein the Guardian either indicates allowance or rejection of access to said media content for the user in a response to the second request authorization message; and
the Control Server updating access rights of the user in the user profile responsive to when said access has been allowed by the Guardian to temporarily penult the user to access said media.

2. The method according to claim 1, further comprising the step of:
responding from the Guardian Terminal to the second authorization request message; and
forwarding by the Control Server the response message to the STB.

3. The method according to claim 1, for generating the second request message, further comprising the steps of:
fetching from a User Profile Server information on the Guardian Terminal; and
collecting Meta Data for the media content to be presented on the Guardian Terminal.

4. The method according to claim 2, further comprising the following steps responsive to when the response from the Guardian Terminal is an accept authorization message:
updating access rights in the User Profile Server; and
including a link to the media content into the response message.

5. The method according to claim 1, wherein the second request authorization message is a SIP message that is sent through a S-CSCF node to the Guardian Terminal.

6. The method according to claim 1, wherein the second request authorization message is an SMS message that is sent through an SMS gateway to the Guardian Terminal.

7. A method in a Control Server for remote authorization of restricted media content distributed in a TV System, the TV system including a Set Top Box (STB) with a user being logged into the TV system and the user being denied access to a media content, said method comprising the steps of:
receiving a first request authorization message from the STB, the message including at least an identifier of the user and an identifier of the media content;
retrieving from a user profile of the user a Guardian Terminal Identifier representing a Guardian who can authorize access to denied content for that user;
generating a second request authorization message, including the identifier of the user, content data and said Guardian Terminal Identifier; and
sending the second request authorization message to the Guardian Terminal by use of the Guardian Terminal Identifier, wherein the Guardian either indicates allowance or rejection of access to said media content for the user in a response to the second request authorization message; and
updating the access rights of the user in the user profile responsive to when said access have been allowed by the Guardian to temporarily permit the user to access said media content.

8. The method according to claim 7, further comprising the following steps:
receiving an accept or reject answer from the Guardian Terminal on the authorization request, and
forwarding the accept or reject message to the STB.

9. The method according to claim 7, further comprising the following steps in the Control Server for the purpose of performing the generation of the second request authorization message:
fetching information on a Guardian Terminal and Guardian Terminal Type and using the information to determine how and where to deliver the second request.

10. The method according to claim 9, wherein the second request authorization message is a SIP message when the Guardian Terminal Type information is IMS, and the second request authorization message is a SMS message when the Guardian Terminal Type information is SMS.

11. A method in the Control Server according to claim 8, further comprising the step of:
including a link to the media content into the authorization message responsive to when it is an accept message.

12. The method according to claim 7, further comprising the following step after the step of sending the second request authorization message:
starting a timer with a predefined time limit for an answer from the Guardian Terminal and responsive to when there is no response received to the Control Server within the time limit, then
sending a reject message to the STB.

13. A Control Server for managing restricted media content in a TV system, the TV system including a Set Top Box (STB) with a user being logged into the TV system and the user being denied access to a media content the Control Server comprising:
a Receiver configured for receiving a first request authorization message from the STB, the message including at least an identifier of the user and an identifier of the media content;
an Interface configured for exchanging electronic signals with at least a Guardian Terminal, for retrieving from a user profile of the user a Guardian Terminal Identifier representing a Guardian who can authorize access to denied content for that user, and for sending a second request authorization message to the Guardian Terminal by use of the Guardian Terminal Identifier, wherein the Guardian either indicates allowance or rejection of access to said media content for the user in a response to the second request authorization message;
a RA Application Memory for storing of a Remote Authorization Application;
a Processor, connected with the Receiver, the Interface and the RA Application Memory, the Processor is configured to generate a Response to the received request by use of the Remote Authorization Application and the electronic signals from the Guardian Terminal; and
a Transmitter configured for transmitting the generated response message back to the STB,
wherein the interface is also configured for updating the access rights of the user in the user profile responsive to when said access has been allowed by the Guardian to temporarily permit the user to access said media content.

14. The Control Server according to claim 13, further comprising:
a Remote Application request memory for correlating the response with the first request authorization message.

15. The Control Server according to claim 13, wherein the interface is connected with a User Profile Server.

16. The Control Server according to claim 13, wherein the interface is connected with a Media Content Database.

17. The Control Server according to claim 13 is an IPTV Control Server.
